(19) United States
(12) Patent Application Publication
(10) Pub. No.: US 2002/0078261 A1
(43) Pub. Date: Jun. 20, 2002

(54) System and method for uniform access of managed data objects

(76) Inventors: Roger Keith Wiles, Corinth, TX (US); Tesfaye Firew, Dallas, TX (US); Richard Wiles, Plano, TX (US); Banu Mohan, Dallas, TX (US)

Correspondence Address: FAY KAPLUN & MARCIN, LLP, 17th Floor, 100 Maiden Lane, New York, NY, 10038, US

(21) Appl. No.: 09/738,787

(22) Filed: Dec. 15, 2000

(51) Int. Cl. G06F 9/46

(52) U.S. Cl. 709/330

(57) ABSTRACT

A method of managing communication between a plurality of components of a computer system comprises the steps of registering at least a portion of the plurality of components with an intermediary module, wherein the intermediary module is coupled to each of the components and providing from a first one of the plurality of components to the intermediary module a request for a data object. The requested data object is then correlated with a second registered one of the components containing the requested data object and the request is forwarded to the second component and fulfilled by providing the requested data object to the first component.

### BACKGROUND INFORMATION

In conventional software systems, data objects are accessed using global references and/or by using a large number of functional Application Program Interfaces (“APIs”). An API is, for example, an interface between an operating system and application programs, which determines the way in which the application programs communicate with the operating system and the services the operating system makes available to the application programs.

In a system implementing networking functions, a network software component typically needs to use an API if it wants to access a corresponding data object in another software component. A problem arises when the data object has been modified or updated because changes to the data object must be tracked by multiple components in the system. Thus, this change to the data object needs to be synchronized for the multiple components. In addition, it may be difficult in certain circumstances to determine which data objects will be needed by a particular network component. Consequently, the particular network component may not have an API suited to access a particular desired data object. Therefore, there is need for a system which would simplify the management of data objects and provide uniform accesses to data objects.

### SUMMARY OF THE INVENTION

The present invention is directed to a method of managing communication between a plurality of components of a computer system, comprising the steps of registering at least a portion of the plurality of components with an intermediary module, wherein the intermediary module is coupled to each of the components and providing from a first one of the plurality of components to the intermediary module a request for a data object in combination with the steps of correlating the requested data object with a second one of the components containing the requested data object, wherein the second component is registered, forwarding the request to the second component and fulfilling the request by providing the requested data object to the first component.

The present invention is also directed to an intermediary module for a software package for facilitating communication among a plurality of components of a computing system, comprising a register of at least a portion of the components and a dispatch component to route a request for a data object received from a first one of the components, the dispatch component correlating the requested data object to a second one of the components containing the requested data object, wherein the second component is included in the register.

### BRIEF DESCRIPTION OF DRAWINGS

FIG. 1 shows an exemplary embodiment of a system according to the present invention.

FIG. 2 shows an exemplary embodiment of an Information Database Plus (“IDB+”) component according to the present invention.

FIG. 3 shows an exemplary embodiment of a control data of the IDB+ engine according to the present invention.

FIG. 4 shows certain tables stored at the IDB+ module.

FIG. 5a shows an exemplary embodiment of a process for generating an IDB+ module.

FIG. 5b shows a flowchart for generating an IDB+ module.

FIG. 6 shows an exemplary embodiment of a method for registering an IDB+ module.

FIG. 7 shows an exemplary embodiment of a method for request fulfillment according to the present invention.

### DETAILED DESCRIPTION

The present invention may be further understood with reference to the following description and the appended drawings, wherein like elements are provided with the same reference numerals. The present invention provides for a fully meshed request-fulfillment system. In particular, such system allows bi-directional communications (e.g., to obtain certain data, share certain data, set predefined values, obtain status reports, etc.) between different modules, components and applications.

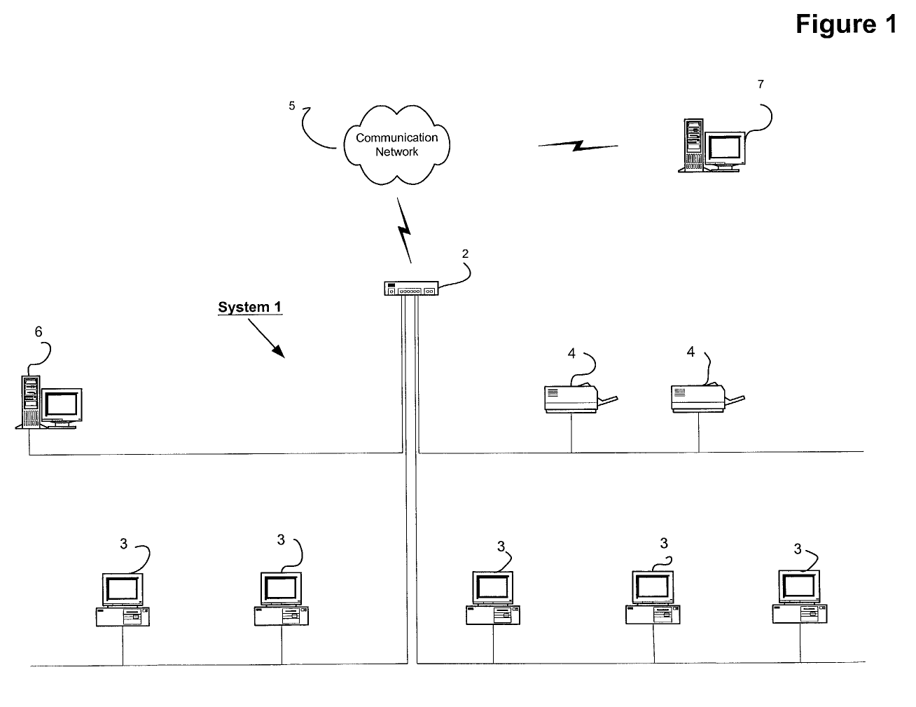

FIG. 1 shows an exemplary system 1 which may include a plurality of devices, such as a switch 2, user computers 3, printers 4 and a server 6. In addition, the switch 2 may be connected to a communication network 5 (e.g., the Internet, a local area network, a wide area network, a wireless network, etc.). A remote server 7 may also communicate with the devices of the system 1 via the communication network 5.

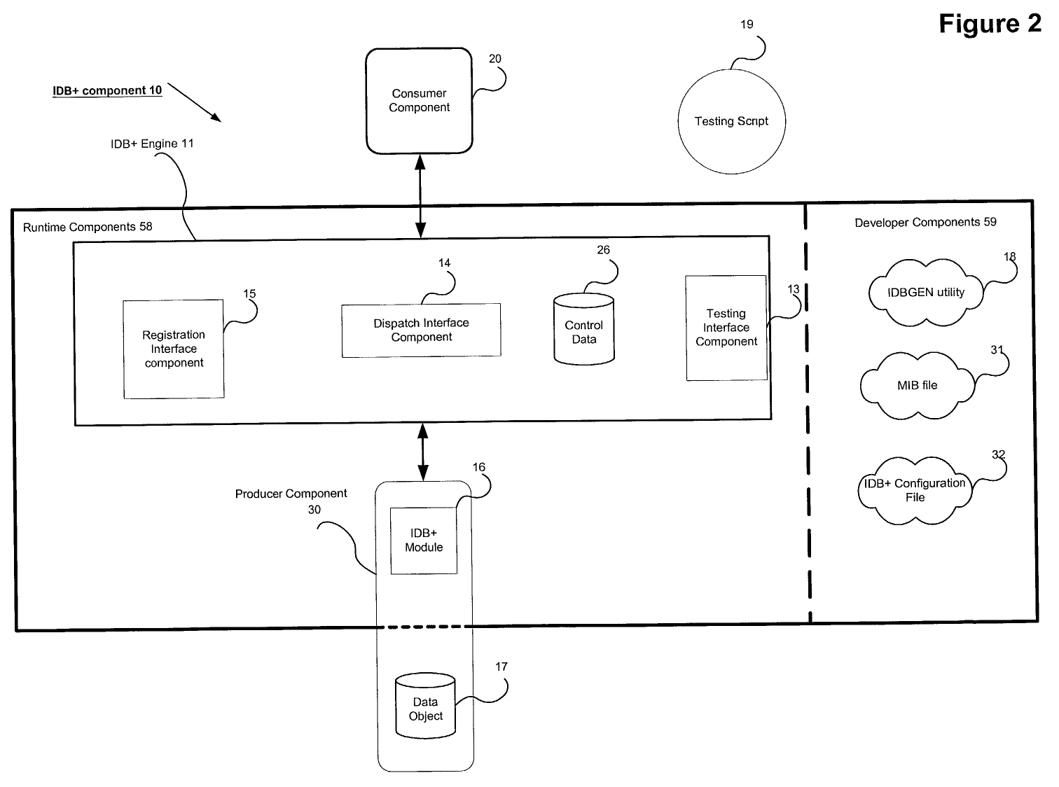

Fulfillment of requests between different components (e.g., a consumer component, a producer component and a hybrid component) may be managed using an Information Database Plus component 10 (“IDB+”) which is shown in FIG. 2. For example, the IDB+ component 10 manages requests submitted by a consumer component 20 to be fulfilled by a producer component 30. The consumer component 20 and the producer component 30 may be situated in the same or different devices within or outside of the system 1. In addition, certain producer components 30 may operate, under particular circumstances, as consumer components 20 (i.e., as a hybrid component as described in detail below).

A consumer component 20 is a component which makes particular requests. The consumer component may be situated within a particular device of the system 1 (e.g., the switch 2) or may be within a device external to the system 1 (e.g., the remote server 7) and connected thereto. The consumer component 20 may be, for example, either of two types: (1) a management type component; and (2) a protocol type component. A consumer component 20 which is a management type component may, for example, be a Simple Network Management Protocol (SNMP) component operating as network management agent software; a Web Management server software component managing web access via the switch 2; an Application Manager component managing applications; a Configuration Management component for a nonvolatile memory; a Console Management component, etc. A consumer component 20 which is a protocol type component may be, e.g., a Spanning Tree Protocol. It should be noted that a Spanning Tree Protocol component may be a hybrid component which means, as described above, that it may act as both a consumer component 20 and a producer component 30.

The producer component 30 is a component which is responsible for the fulfillment of requests (e.g., Set, Get, GetNext, etc.) generated by consumer components 20. The producer component 30 may include at least one data object 17, for example, data requested by the consumer component 20. The producer component 30 may include data link layer components (e.g., components of Layer 2) and network layer components (e.g., components of Layer 3) of the Open Systems Interconnection networking model. The data link layer components are generally concerned with issues related to the transmitting and/or receiving of data packets (e.g., these components may detect and correct errors in the physical layer).

The network layer components direct the routing of packets of data between components via the data link layer. The most common network layer protocol component is a Network Routine Stack TCP/IP. The network layer component may also include an Open Shortest Path First (OSPF) component; and a Routing Information Protocol (RIP) component providing routing information as to the networks presently accessible and the number of hops required to reach each accessible network. In addition, the network layer component may include an Internet Group Multicast Protocol (IGMP) component, etc.

As mentioned above, a hybrid component (not shown in the drawings) is a producer component 30 which also operates, under certain conditions, as a consumer component 20. The hybrid component may fulfil certain requests from a consumer component 20 (e.g., a Spanning Tree Protocol, a Generic Attribute Registration Protocol, etc.), and may also generate requests to be fulfilled by another producer component 30.

The IDB+ component 10 may handle a plurality of requests (e.g., “Get”, “GetNext”, “Set”, “ForceSet”, “Validate”, “Commit”, “NVMSet” and other requests). The Get request is a data request from a consumer component 20 for a certain data object from a producer component 30. The GetNext request may allow the consumer component 20 to obtain the value of the next data object 17 of the IDB+ module 16 (assuming one exists). The Set request allows the value of a particular data object 17 to be set to a predetermined value. The Set request consists of two requests, first a Validate sub-request performs an initial validation of the object value to which the data object 17 is to be set by the Set request. Then a Commit sub-request sets the value of the data object 17. The ForceSet request allows the value of a read-only data object 17 to be set to a selected value. The NVMSet allows the value of a data object 17 to be set in a nonvolatile memory (e.g., Flash memory), so that the value may be recovered from the nonvolatile memory after the system is reinitialized following some event, for example, a loss of power to the system. Additionally, the IDB+ component 10 may handle a request to perform operations on a row of table objects, e.g., Row Set, Row Get and Row GetNext, etc. Such operations may require several data objects 17 to be set at one time based on a single request.

Using an example where all the components reside on a single processor, for example, the processor of switch 2 of FIG. 1. Referring to FIG. 2 to further illustrate this example, it may be considered that switch 2 has multiple consumer components 20 and producer components 30 that reside on the processor of switch 2. Those skilled in the art will understand that the term reside in this example means that the processor of switch 2 has access to the above mentioned components and it does not necessarily mean that at any given time these components are stored within the memory of the processor. These components may be stored in system memory, for example, Random Access Memory (“RAM”), which is accessible by the processor. One of the consumer components 20 of the switch 2 may need statistical data regarding a number of data packets that passed through a first port of one of the producer components 30 of switch 2. In a conventional system, each of the consumer components 20 and producer components 30 must have applications that allow these two components 20, 30 to “talk” to one another. However, according to the present invention, when a particular consumer component 20 needs certain data stored in the data object 17 of a particular producer component 30, the consumer component 20 does not contact the producer component 30 directly. Instead, the consumer component 20 submits the Get request to the IDB+component 10, which also resides on the processor of switch 2. The IDB+ component 10 then forwards the Get request to the appropriate producer component 30. Each of the consumer components 20 and producer components 30 have specific routines that allows them to communicate with an intermediary, i.e., the IDB+ component 10. After the requested data has been obtained from the producer component 30, it is forwarded to the consumer component 20 via the IDB+ component 10.

As a further example, the switch 2 may have a chassis arrangement where multiple cards may be inserted into the slots of the chassis, and each card may or may not have a separate processor. A processor of a first card may wish to disable a particular port of a second card in switch 2. The consumer component 20 of the first card generates a Set request and forwards the request to a producer component 30 of the second card corresponding to the port to be disabled via the IDB+ component 10. As will be described in more detail below, an IDB+ engine 11 of the IDB+ component 10 finds an IDB+ module 16 corresponding to the producer component 30 of the second card and forwards the request to the IDB+ module 16. The IDB+ module 16 fulfills the request by disabling the port, e.g., by setting the producer component 30 of the second card to zero. Those of skill in the art will understand that the preceding examples show where the consumer components 20 and producer components 30 reside on the same computing device (e.g., switch 2), but it may also be possible using the present invention to communicate between various components residing on different computing devices (e.g., server 6 and user computer 3, server 7 and printer 4, etc.)

The IDB+ Component

FIG. 2 shows an exemplary embodiment of the IDB+ component 10 according to the present invention. The IDB+ component 10 is separated into two main component groups, runtime component group 58 and developer component group 59. Each of component groups 58 and 59 will be discussed in detail. Runtime component group 58 includes two main components: (1) an IDB+ engine 11 and (2) a plurality of IDB+ modules 16. Those of skill in the art will understand that runtime component group 58 is not limited to these two main components 11 and 16, but may also include other components as needed for specific applications. The IDB+ engine 11 is a main processing module operating as an interface between the consumer component 20 and the producer component 30. Requests between the consumer component 20 and the producer component 30 are routed via the IDB+ engine 11.

The IDB+ engine 11 may include a dispatch interface component 14 which routes the consumer component 20 request to a corresponding one of the IDB+ modules 16. A registration interface component 15 of the IDB+ engine 11 may allow the producer component 30 to dynamically register and/or de-register a particular IDB+ module 16 with the IDB+ engine 11. Furthermore, the IDB+ engine 11 may include a testing interface component 13 running tests on the IDB+ component 10 to detect malfunctions therein. Testing script 19 may be used to perform these tests.

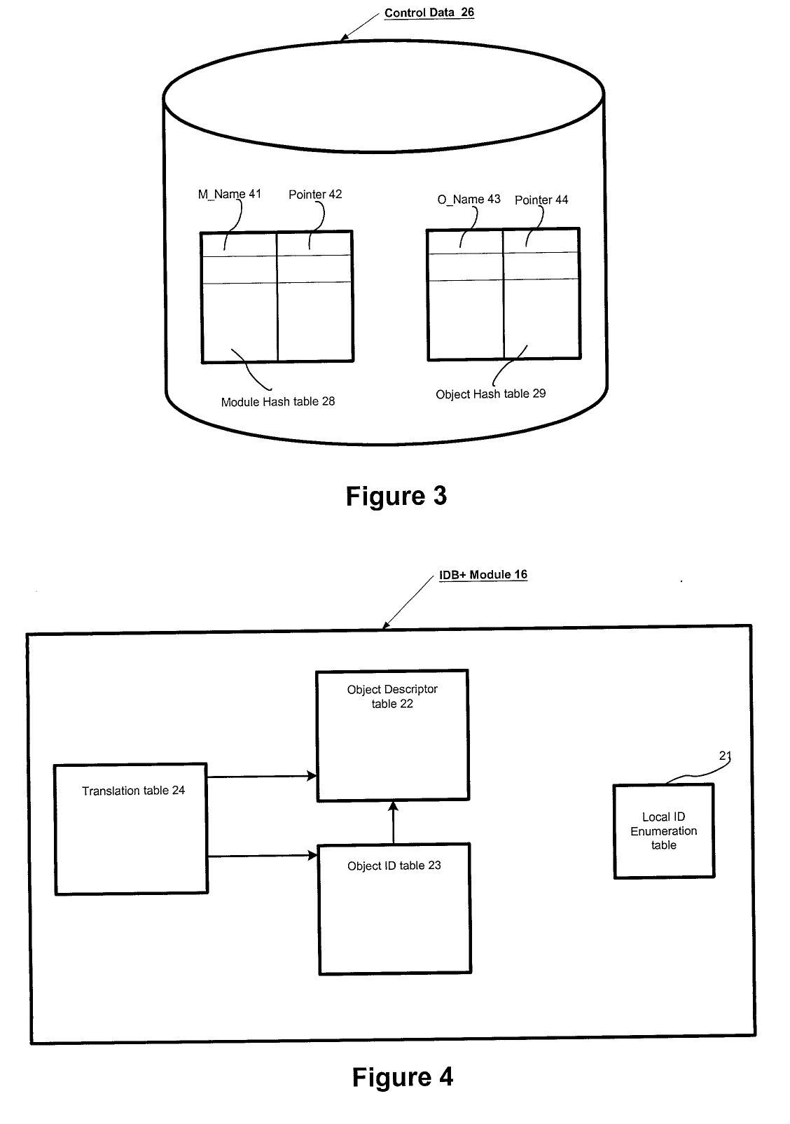

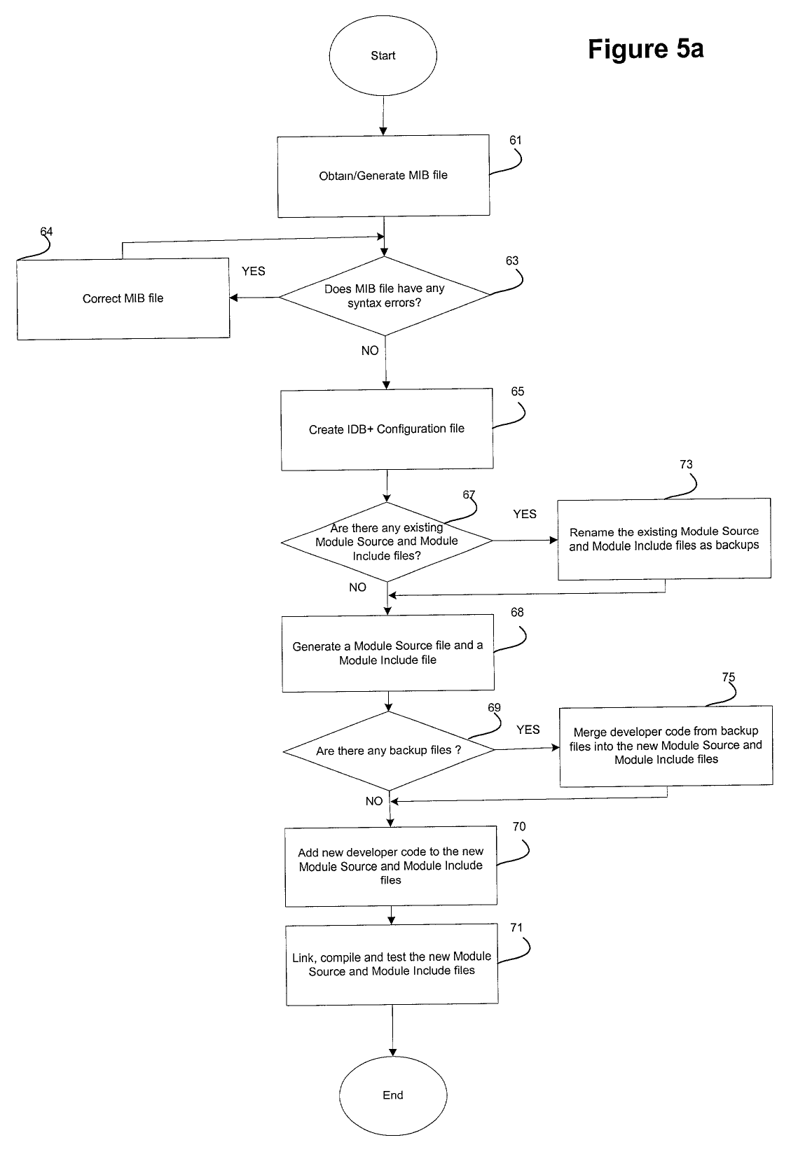

Finally, the IDB+ engine 11 may include control data 26 storing a plurality of tables. In particular, control data 26 may store, as shown in FIG. 3, a Module Hash table 28 and an Object Hash table 29. The Module Hash table 28 includes a list of every IDB+ module 16 registered with the IDB+ component 10. In particular, the Module Hash table 28 may include for each IDB+ module 16 (1) a name of the IDB+ module 16 (e.g., M_Name 41) and (2) a corresponding pointer 42 to a Translation table 24 (described in detail below and shown in FIG. 4). The Object Hash table 29 may include for each data object 17 of each of the corresponding IDB+ modules 16 (1) a name of the data object 17 (e.g., O_Name 43) and (2) a corresponding pointer 44 to an entry in the Translation table 24. Those of skill in the art will understand that the hash tables 28 and 29 described above are not the only mechanisms that may be used by control data 26 to register and correlate IDB+ modules 16 and data objects 17. Other mechanisms that may be used alone or in conjunction with hash tables may include, for example, database implementations and balanced binary trees (e.g., Adelson-Velskii and Landis (“AVL”) tree).

As will be described in greater detail below, the IDB+ module 16 may be defined by the Management Information Base (“MIB”) file 31 using, e.g., the ASN.1 syntax used by SNMP. SNMP may be used by software programs called agents to monitor and control data on a network device utilized to create the MIB database. The IDB+ module 16 is an individual manageable entity supporting data access to a representative data object 17. The IDB+ module 16 may include, as shown in FIG. 4, a local ID enumeration table 21 which includes a list of local IDs for data object 17. Furthermore, the IDB+ module 16 may include the Translation table 24, the Object Descriptor table 22 and the Object ID table 23. As described above, Object Hash table 29 may have a pointer 44 that points to an entry in the translation table 24. When IDB+ engine 11 is looking up a data object 17 in an IDB+ module 16, control data 26 uses the correlation between the O_Name 43 and the pointer 44 to get to the correct entry in translation table 24.

The Translation table 24 of an IDB+ module 16 may be registered with the IDB+ engine 11 either during an initialization process or dynamically during operation of the system. The Translation table 24 then has pointers to both the Object Descriptor table 22 and the Object ID table 23. The Object Descriptor table 22 has a predefined data structure including information about each data object 17. The data structure may include, for example, the following data for each of the data objects 17: a local ID (a list of local Ids is stored in the Local ID table 21), a size of the data object 17, a valid range of values for the data object 17, a type of the data object 17, access rights, a flag indicating the status of the data object 17 (e.g., valid or invalid), a function pointer to the dispatch handler function, a first pointer to the name string of an alternate data object 17 and a second pointer to the name string of the data object 17 itself. The first pointer is utilized when the data object 17 is supported by other data objects 17. In particular, the listing of a name string for an alternate data object 17 allows the request fulfillment process to be simplified in cases where a call to a first data object 17 would trigger a call to a second data object 17 which in turn may call for a third data object 17. To avoid unnecessary delay, the first data object 17 would include a pointer to the third data object 17 which is “the alternate data object” for the first data object 17.

The Object ID table 23 may include identification and indexing mechanisms for each table and for each scalar of the data objects 17. The Object ID table 23 may include, for example, a structure type (e.g., SNMP) with each record having an Object ID prefix, a particular length and an index count which is a number of indices in an index name array and a pointer to the corresponding Object Descriptor table 22 as shown in FIG. 4. The Object ID prefix designates the class of an object. An index name array includes the name strings for the indices of the MIB table in which data object 17 resides. In summary, once the data object 17 is found in the Object Hash table 29, the corresponding pointer to an entry in the Translation table 24 and the pointers to the information in the Object Descriptor table 22 and Object ID table 23 provide sufficient information for the request fulfillment process to begin. The request fulfillment process is described in greater detail below.

Creation of IDB+ Modules

Referring back to FIG. 2, developer components group 59 of IDB+ component 10 includes three main components: (1) an IDBGEN utility 18, (2) a MIB file 31 and (3) an IDB+ Configuration file 32. The IDBGEN utility 18 operates in conjunction with the IDB+ configuration file 32 on the MIB file 31 to generate new IDB+ modules 16. The IDBGEN utility 18 may have automatic features which generate a skeleton (e.g., a C language framework) for the IDB+ module 16 using the MIB file 31 and the IDB+ configuration file 32. The developer may then add additional code to the skeleton to support requests for data objects 17 in the newly created IDB+ module 16.

The IDB+ configuration file 32 is a configuration control file that is used by the IDBGEN utility 18 and may be customized for its associated MIB file 31. The MIB file 31 may be standard Management Information Base object definitions as defined by Request for Comments (RFCs) or they may be other user defined object definitions as defined, for example, in an enterprise MIB. The MIBs may be, for example, those defined in RFC 1213 (Management Information Base for Network Management of TCP/IP-based internets: MIB-II), RFC 1493 (Definitions of Managed Objects for Bridges), RFC 1515 (Definitions of Managed Objects for IEEE 802.3 Medium Attachment Units), or RFC 1757 (Remote Network Monitoring Management Information Base).

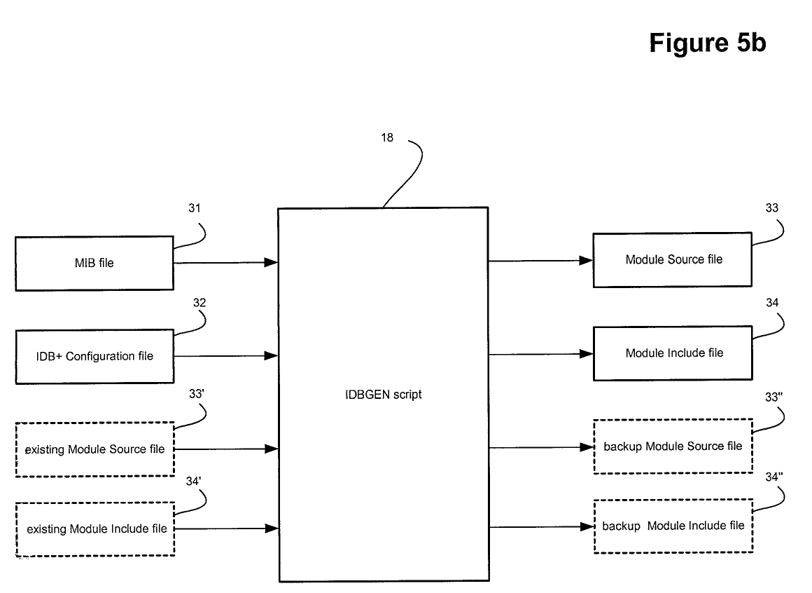

FIGS. 5a and 5b show an exemplary process for generating an IDB+ module 16. In step 61, the MIB file 31 is obtained (standard RFC MIB) or created (enterprise MIB). The process then continues to step 63 where it is determined whether the MIB file 31 has any syntax errors. This syntax check may be accomplished by pre-compiling the MIB file 31. If syntax errors are found, the process continues to step 64 where the developer corrects the syntax errors in the MIB file 31. The process then loops back to step 63 to determine whether the syntax has been corrected. Steps 63 and 64 form an iterative loop to assure that the MIB file 31 does not contain any syntax errors before proceeding with further steps in the process.

If the MIB file 31 includes no syntax errors, an IDB+ configuration file 32 is created for this MIB file 31 in step 65. As described above, the IDB+ configuration file 32 is a configuration control file that may be customized for its associated MIB file 31. The IDB+ configuration file 32 may contain a series of configuration parameters, for example, the name of the MIB file 31; the name of the IDB+ module 16 to be created; where the IDB+ module 16 source (e.g., c files) and include files (e.g., .h files) are generated; prerequisite MIB files 31 that may be required to compile the current MIB file 31, including a search path for these prerequisite MIB files; and any alternate data objects 17. Those skilled in the art will understand that the configuration parameters listed above are only exemplary and that there may be other configuration parameters depending upon the specific MIB file 31.

The process then continues to step 67, where the IDBGEN utility 18 determines whether either a Module Source file 33′ or a Module Include file 34′ exists (See FIG. 5b). If the Module Source file 33′ and the Module Include file 34′ for the IDB+ module 16 already exist, the process proceeds to step 73 where the IDBGEN utility 18 renames the existing Module Source file 33′ and Module Include file 34′ as a Backup Module source file 33″ and a Backup Module Include file 34″.

If there is no existing Module Source file 33′ or Module Include file 34′ in step 67 or after the files have been renamed in step 73, the process continues to step 68, where, based on the MIB file 31 and the IDB+ configuration file 32, the IDBGEN utility 18 generates (1) a Module Source file 33 and (2) a Module Include file 34 for the IDB+ module 16 being created. The Module Source file 33 includes the Translation table 24, the Object Descriptor table 22 and the Object ID table 23, including the corresponding pointers between the tables 22-24 described above. In addition, the Module Source file 33 may include an initialization routine, dispatch handler routine(s) and a termination routine. The initialization routine performs an initialization procedure that may include a registration procedure for registering the IDB+ module 16 with the IDB+ engine 11. The dispatch handler routine(s) implement the requests of the consumer components 20. The termination routine “cleans up” the IDB+ module 16 after it has been de-registered with the IDB+ engine 11. The Module Include file 34 may include, for example, local ID enumerations, MIB object enumerations, MIB object sizes and function prototypes.

In step 69 it is determined whether there is a Backup Module Source file 33″ or a Backup Module Include file 34″ that were renamed in step 73. As will be described later in the current process with respect to step 70, a developer may add lines of code to the Module Source file 33 and the Module Include file 34. If in step 69, it is determined that there is a Backup Module Source file 33″ or a Backup Module Include file 34″, it is possible that the developer had previously added lines of code to these backup files 33″ and 34″ before they were renamed. In this case, the process continues to step 75 where these lines of code added to the backup files 33″ and 34″ are merged in the appropriate locations in the Module Source file 33 and Module Include file 34 that were newly created in step 68.

After this merge in step 75 or if it is determined that there are no backup files 33″ or 34″ in step 69, the process continues to step 70 where a developer may add additional lines of code to the newly created Module Source file 33 and the Module Include file 34. This new developer code may be added to implement desired functionality in the IDB+ module 16. When the IDBGEN utility 18 generates the new Module Source file 33 and Module Include file 34 in step 68, it may provide locations within the code for a developer to add these new lines of code.

If, for example, IDBGEN utility 18 generated the new Module Source file 33 and Module Include file 34 in the C programming language, it may provide beginning and end comment tag pairs. These comment tag pairs may be in the following form:

/* %%Begin User Tag Name */

/* %%End User Tag Name */

The developer may then insert any additional lines of code between these comment tag pairs to implement any desired functionality in the IDB+ module 16. The tag name may identify the type of code that may be inserted between the comment tag pairs. A tag name may be, for example, Include_Files, Globals, etc. Thus, the developer may insert additional include files between the comment tag pair having the tag name Include_Files. Likewise, the developer may insert additional global variables between the comment tag pair having the tag name Globals. This manner of inserting code also provides a manner of identifying which code was automatically generated by the IDBGEN utility 18 and which code was inserted by a developer. Thus, if the Module Source file 33 and Module Include file 34 are ever renamed as backup files 33″ and 34″, the code added by the developer to these files may be identified and merged into any new Module Source file 33 and Module Include file 34, as described above with respect to step 75.

The process then continues to step 71 where the Module Source file 33 and the Module Include file 34 are linked and compiled to generate the required IDB+ module 16 which is then tested. If the testing process is successful, the process ends and the IDB+ module 16 is ready for use in the system. If the testing is unsuccessful, the process may loop back to a point where the developer modifies MIB file 31 (step 61) and/or IDB+ configuration file 32 (step 65). However, the unsuccessful testing may be a result of the code added by the developer to the Module Source file 33 and/or the Module Include file 34. In this case, the process will only need to loop back to step 70 where the new code is added by the developer.

FIG. 5b shows a flowchart for generating an IDB+ module 16. As described above, if there is an existing Module Source file 33′and/or an existing Module Include file 34′, the IDBGEN utility 18 will rename these files as backup Module Source file 33″ and backup Module Include file 34″, respectively. The IDBGEN utility 18 will also use the MIB file 31 and the IDB+ configuration file 32 to create a new Module Source file 33 and Module Include file 34.

Registration/De-Registration Procedure

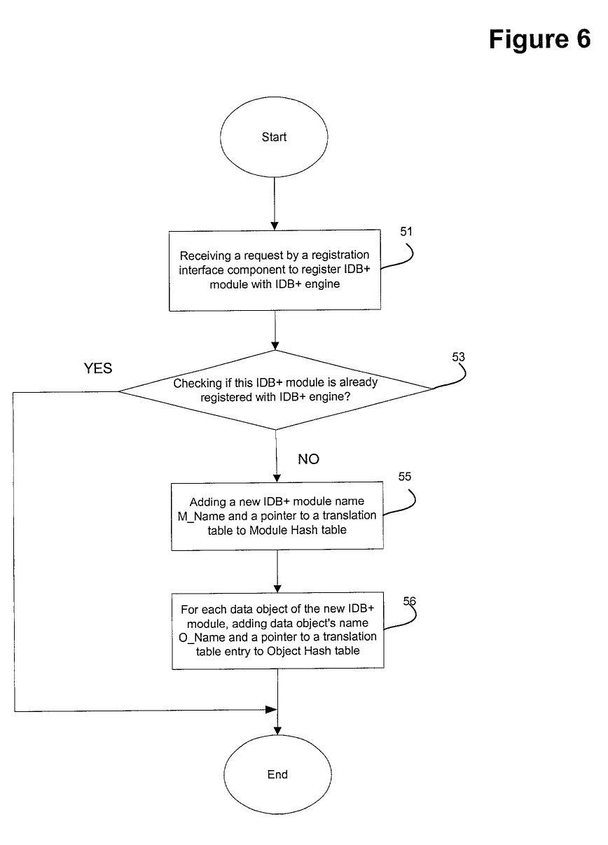

FIG. 6 shows an exemplary registration procedure for the IDB+ module 16 according to the present invention. In step 51, a request to register an IDB+ module 16 is received by the registration interface component 15 of the IDB+ engine 11. Such request may come either (a) during an initialization process when every IDB+ module 16 has to register with the IDB+engine 11 or (2) when a new producer component 30 is added.

The registration interface component 15 first determines if the IDB+ module 16 was previously registered with the IDB+ engine 11. Such determination is made by checking the Module Hash table 28, in particular, by checking M_Name 41 (step 53). If the IDB+ module 16 is already registered, the process ends. If the IDB+ module 16 has not previously been registered, the new M_Name 41 and a corresponding pointer 42 to the translation table 24 are added into the Module Hash table 28 (step 55). In step 56, the name of the each data object 17 of the new IDB+ module 16 (i.e., O_Name 43) and a corresponding pointer 44 to the entry in the translation table 24 are added the Object Hash table 29. Once the Module Hash and Object Hash tables 28, 29 have been updated, the IDB+ module 16 is considered to be fully registered with the IDB+ engine 11.

A de-registration procedure for IDB+ modules 16 is similar to the registration procedure for IDB+ modules 16 described above. The de-registration procedure is initiated when an IDB+ module 16 is removed and/or deactivated. During the de-registration procedure, the Module Hash and Object Hash tables 28, 29 are updated to remove references to the removed IDB+ module 16 (i.e., M_Name 41, O_Name 43 and the corresponding pointers 42, 44). This procedure may be done dynamically in real time or at a predefined time.

Request Fulfillment Process

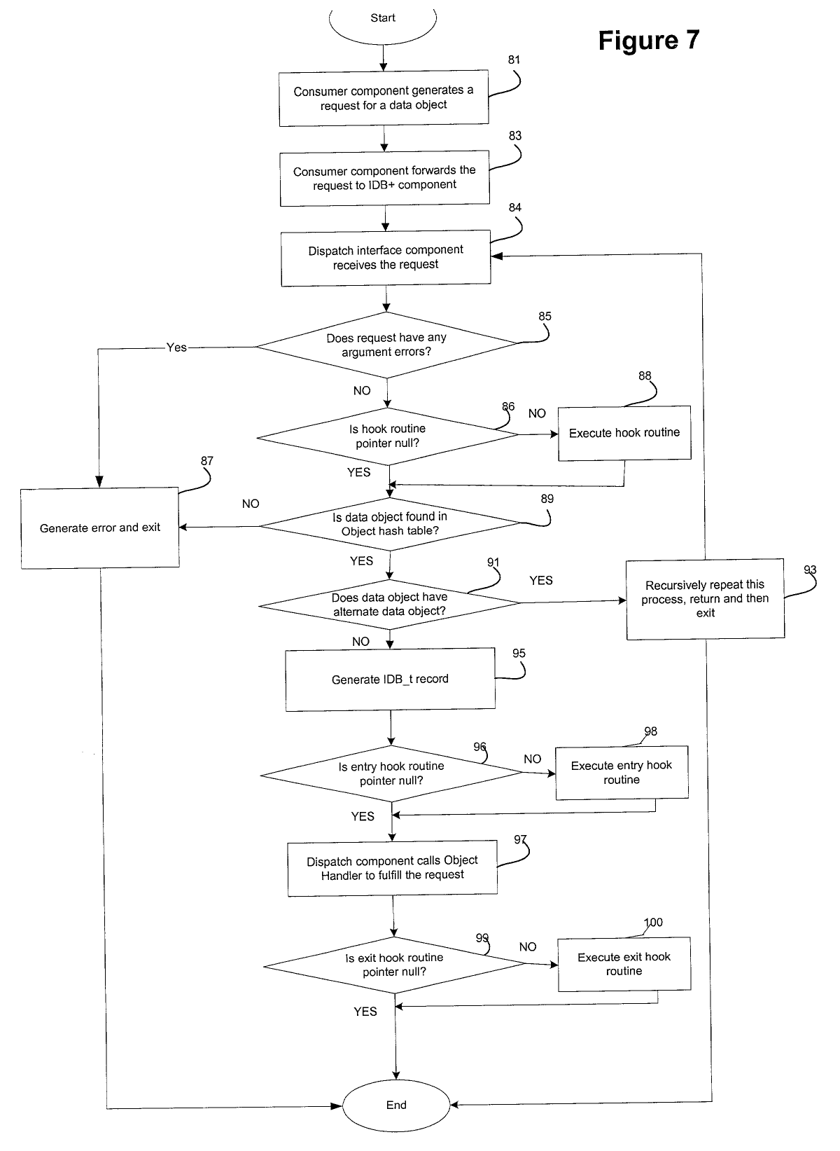

FIG. 7 shows an exemplary method according to the present invention for fulfilling requests using an IDB+ component 10 as described above. Another term that may be used in this description to describe this fulfillment process is dispatch routine. In step 81, the consumer component 20 generates a request for a particular data object 17. This data object 17 is located at and controlled by the producer component 30 and may be accessed by the corresponding IDB+ module 16. For example, the consumer component 20 may submit a Get request for certain data stored in a data object 17 of the producer component 30.

The consumer component 20 forwards the request to the IDB+ component 10 (step 83). The request is received by the dispatch interface component 14 of the IDB+ engine 11 of the IDB+ component 10 (step 84) and, in step 85, the dispatch interface component 14 determines whether the request includes any argument errors. In particular, the dispatch interface component 14 may check an object tag string in the request to identify the desired data object 17, an identification of a buffer for the desired data object 17 and predetermined sub-identifiers.

If the dispatch interface component 14 finds any argument error(s) in the request, a corresponding error message is generated in step 87 and the dispatch routine is aborted. However, if no argument errors are found, the process continues to step 86 where it is determined whether the hook routine pointer is null. A hook routine allows a developer to add additional code to the dispatch routine. This additional code may be used to modify the dispatch routine in order to add any desired functionality to the dispatch routine. It should be noted that these hook routines are added to the dispatch routine during the development process and not during runtime. The developer may initialize the pointer to a non-null state during the setup of the system. Likewise, during operation it is also possible to set the pointer back to the null state or to point to a different hook routine. The process currently being described is a runtime process that only determines whether the hook routine pointer is null, it does not add the hook routine. If a hook routine was added during the development process, the hook routine pointer would not be null, and the process would continue to step 88, where the hook routine would be executed. At this point in the process, the added hook routine may be, for example, a routine to change the name of data object 17.

After the hook routine executes in step 88 or if the hook routine pointer is null in step 86, the process continues to step 89 where the dispatch interface component 14 initiates a search for the requested data object 17. In particular, the dispatch interface component 14 searches in the Hash Object table 29 for the object tag string in the request. If the data object 17 is not found in the Hash Object table 29, the process continues to step 87 where a corresponding error message is generated and the dispatch routine is aborted.

If the requested data object 17 is found, the process continues to step 91 where the dispatch interface component 14 checks for an alternate data object 17. As described above, an alternate data object 17 is one where a first data object 17 is supported by another data object 17. In particular, the listing of a name string for an alternate data object 17 allows the request fulfillment process to be simplified in cases where a call to a first data object 17 would trigger calls to one or more additional data objects 17. The first data object 17 includes a pointer to the other supporting data object 17 which is “the alternate data object” for the first data object 17. If an alternate data object 17 corresponding to the requested data object 17 exits, the process continues to step 93 where the dispatch interface component 14 recursively calls this same process (the dispatch routine) starting with step 84. In this case, the dispatch interface component 14 would receive a request addressed to the alternate data object 17 instead of a request for the original requested data object 17. This recursively called dispatch routine would go through all the applicable steps of the currently described process (steps 84-100) until the alternate data object 17 is processed. When the recursively called dispatch routine is finished processing the alternate data object 17, the process returns to step 93 in the originally called dispatch routine. Since the alternate data object 17 has been processed in the recursively called dispatch routine, there is no need to continue processing the original data object 17 and therefore, the original dispatch routine may be ended. Thus, step 93 shows an arrow going back to step 84 to show the recursively called dispatch routine and an arrow going to the end of the routine to show that the original dispatch routine may be ended when the recursively called dispatch routine has completed processing the alternate data object 17.

If there is no alternate data object 17, the dispatch interface component 14 generates an IDB_t record for this request (step 95). The IDB_t record includes certain information regarding the data object 17 (e.g., local ID, flags, index, etc.) and is created as a function of information stored in the Object Descriptor table 22 and the Object ID table 23. The process then continues to step 96 to determine if the entry hook routine pointer is null. As described above, a hook routine allows a developer to add additional code to the dispatch routine. If the entry hook routine pointer is not null, the process continues to step 98 where the entry hook routine is executed. If the entry hook routine pointer is null in step 96 or after the entry hook routine has been executed in step 98 the process continues to step 97.

In step 97, the dispatch interface component 14 calls an Object Handler routine in the corresponding IDB+module 16 to implement the request. The object handler then fulfills the request(e.g., retrieves desired data (Get), sets a particular value (Set), etc.) in regard to the requested data object 17 based on the information stored in the IDB_t record. The process then continues to step 99 to determine if the exit hook routine pointer is null. If the exit hook pointer is not null, the process continues to step 100 to run the exit hook routine. An example of an exit hook routine that a developer may add to the dispatch routine is where a particular data object 17 may need to be set in two different IDB+ modules 16. The exit hook routine may, after the first set, go to the second IDB+ module and perform the same set routine.

One of the advantages of the present invention is that the discussed system and method provide for uniformly structured and controlled request fulfillment. Such access is fully meshed access, i.e., every module component is afforded equal bi-directional access to every data object 17.

Yet another advantage of the present invention is that it allows for an efficient way to synchronize data between different application, component and devices. Furthermore, an access policy may be set for monitoring and controlling fulfilment of requests between different components.

There are many modifications to the present invention which will be apparent to those skilled in the art without departing form the teaching of the present invention. The embodiments disclosed herein are for illustrative purposes only and are not intended to describe the bounds of the present invention which is to be limited only by the scope of the claims appended hereto.

What is claimed is:

1. A method of managing communication between a plurality of components of a computer system, comprising the steps of:
registering at least a portion of the plurality of components with an intermediary module, wherein the intermediary module is coupled to each of the components;
providing from a first one of the plurality of components to the intermediary module a request for a data object;
correlating the requested data object with a second one of the components containing the requested data object, wherein the second component is registered;
forwarding the request to the second component; and
fulfilling the request by providing the requested data object to the first component.

2. The method according to claim 1, wherein the computing system comprises a plurality of devices.

3. The method according to claim 1, wherein the plurality of components includes a producer component and a consumer component, the producer component fulfilling at least a portion of requests made by the consumer component.

4. The method according to claim 3, wherein the plurality of components further includes a hybrid component which, under predetermined conditions, acts as a consumer component and which otherwise acts as a producer component.

5. The method according to claim 1, wherein all of the components reside on a single processor.

6. The method according to claim 4, wherein the intermediary module receives a plurality of requests from the consumer component including at least one of a request to retrieve a value in the a data object from the producer component, a request to retrieve a value in a next data object of the producer component, a request to set a value in the data object of the producer component, a request to set a read-only value of the data object of the producer component and a request to store a value of the data object in a nonvolatile memory.

7. The method according to claim 1, wherein the intermediary module performs the correlating step using one of a hash table, a database application and a binary tree.

8. The method according to claim 5, wherein the single processor operates a switching device.

9. The method according to claim 1, further comprising the step of deleting from the register reference to a deleted component which has been decoupled from the intermediary module.

10. An intermediary module for a software package for facilitating communication among a plurality of components of a computing system, comprising:
a register of at least a portion of the components; and
a dispatch component to route a request for a data object received from a first one of the components, the dispatch component correlating the requested data object to a second one of the components containing the requested data object, wherein the second component is included in the register.

11. The intermediary module according to claim 10, wherein the dispatch component communicates with a plurality of manageable entities, each of the manageable entities corresponding to one of the registered components and directing a request for a data object contained within the corresponding registered component to a location of the requested data object within the registered component.

12. The intermediary module according to claim 11, further comprising:
a configuration component containing configuration parameters for the manageable entities; and
a utility for generating the manageable entities using the configuration component.

13. The intermediary module according to claim 10, wherein the register includes control data relating a plurality of data objects with corresponding ones of the plurality of registered components.

14. A system for managing communications among a plurality of components of a computing system comprising:
a consumer component;
a plurality of producer components; and
an intermediary module receiving from the consumer component requests for data objects, wherein, upon receipt of a consumer component request, the intermediary module consults a register to identify a registered one of the producer components in which the data object is contained.

15. The system according to claim 14, wherein the intermediary module communicates with a plurality of manageable entities, each of the manageable entities corresponding to one of the registered components and directing a requests for data object contained within the corresponding registered component to a location of the requested data object within the registered producer component.

16. The system according to claim 14, wherein the system operates a switch.

17. The system according to claim 14, wherein the intermediary module receives a plurality of requests from the consumer component including at least one of a request to retrieve a value in the a data object from the producer component, a request to retrieve a value in a next data object of the producer component, a request to set a value in the data object of the producer component, a request to set a read-only value of the data object of the producer component and a request to store a value of the data object in a nonvolatile memory.

18. The system according to claim 14, further comprising a hybrid component which, under predetermined conditions, acts as a consumer component and which otherwise acts as a producer component.
